(19) United States
(12) Patent Application Publication
(10) Pub. No.: US 2008/0100883 A1
(43) Pub. Date: May 1, 2008

(54) Device and method for inputting information

(75) Inventor: Hyun-ki Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/707,899

(22) Filed: Feb. 20, 2007

(30) Foreign Application Priority Data
Oct. 25, 2006 (KR) 10-2006-0104028

(51) Int. Cl. H04N 1/04

(52) U.S. Cl. 358/482

(57) ABSTRACT

A device and a method for inputting information are provided. The device includes: a rod; a movable ring fitted over the rod such that the rod is inserted through the movable ring, the movable ring moving in at least one of a longitudinal direction and a rotation direction of the rod; and a detector provided on the rod to sense a movement of the movable ring on the rod so as to generate information corresponding to the movement of the movable ring.

### CROSS-REFERENCE TO RELATED PATENT APPLICATION

This application claims priority from Korean Patent Application No. 10-2006-0104028, filed on Oct. 25, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to inputting information, and more particularly, to inputting information using a rod such as an antenna.

2. Description of the Related Art

In related art technologies, operating panels include keys to operate various functions of electronic products. The various functions of electronic products are complicated and are correlated with one another rather than independent of one another. Thus, users classify and recognize the various functions of the electronic products. As a result, keys having directions are disposed on the operating panels to operate the various functions of the electronic products so as to effectively select the necessary functions on classified menus. The keys are called direction keys or navigation keys.

Related art direction keys include four buttons, i.e., up, down, left, and right buttons, and a confirmation button. Electrical contact points such as a tact switch or a conductive rubber switch spaced apart from each other are pressed or slid so that the direction keys contact one another. However, the positions for installing such direction keys are very limited in mobile devices such as mobile communication terminals. As mobile communication terminals are becoming more compact, the spaces allocated for the direction keys are becoming smaller. Also, mobile devices such as MP3 players or personal multimedia players (PMPs) select contents from hundreds, thousands of content lists. As such, the related art direction keys require a large amount of time to search content lists, i.e., move within menus.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a device and a method for inputting information by which a rod type structure such as an antenna of an audio communication device can be used to input information to the device so as to make the device compact, make the time required for moving within menus can be reduced, and make the device can be easily manipulated.

According to an aspect of the present invention, there is provided an information inputting device including: a rod; a movable ring that is fitted over the rod such that the rod is inserted through the movable ring, the movable ring moves in at least one of a longitudinal direction and a rotational direction of the rod; and a detector that is provided on the rod to sense a movement of the movable ring so as to generate information corresponding to the movement of the movable ring.

According to another aspect of the present invention, there is provided a method of sensing a movement of a movable ring, the method including: sensing the movement of the movable ring on the rod; and generating information corresponding to the sensed movement.

### BRIEF DESCRIPTION OF THE DRAWINGS

The above and other aspects of the present invention will become more apparent by describing in detail exemplary embodiments thereof with reference to the attached drawings in which:

FIG. 1 is a schematic plan view illustrating an information inputting device according to an exemplary embodiment of the present invention;

FIG. 2 is a schematic perspective view illustrating the information inputting device illustrated in FIG. 1, according to an exemplary embodiment of the present invention;

FIG. 3 is a schematic block diagram illustrating the information inputting device illustrated in FIG. 1, according to an exemplary embodiment of the present invention;

FIG. 4 is a view illustrating a tree structure of a manipulation menu according to an exemplary embodiment of the present invention;

FIG. 5 illustrates a flowchart of a method of inputting information according to an exemplary embodiment of the present invention; and

FIGS. 6 and 7 are views illustrating a manipulation menu of a display with information input by direction keys according to exemplary embodiments of the present invention.

### DETAILED DESCRIPTION OF THE INVENTION

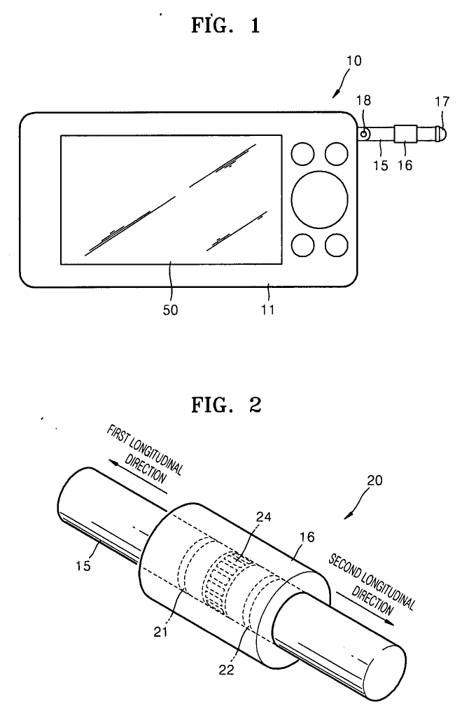

FIG. 1 is a schematic plan view of an information inputting device 10 according to an exemplary embodiment of the present invention. Referring to FIG. 1, the information inputting device 10 according to the present exemplary embodiment includes a body 11, a display 50, a rod 15, and a movable ring 16. The display 50 of the information inputting device 10 is provided on a front surface of the body 11 to display a manipulation menu. The rod 15 of the information inputting device 10 is provided on an end of the body 11. The movable ring 16 is fitted over the rod 15 to select the manipulation menu such that the rod 15 is inserted through the movable ring 16.

The body 11 may be a portable audio communication device, an MP3 player, a personal multimedia player (PMP), or the like.

The rod 15 is provided on an end of the body 11. The rod 15 has a cylindrical or polygonal prism shape. An axis of the rod 15 is not limited to a straight line but may be a curved line. However, as will be described later, a section of a portion of the rod 15 on which the movable ring 16 rotates may be a circular shape or an equilateral polygon shape that is close to the circular shape so that the movable ring 16 easily rotates around the rod 15. The rod 15 may have a retractable structure like a retractable antenna. The retractable structure of the rod 15 may be hollow and have a plurality of poles of different sizes, which may overlap with one another in a longitudinal direction.

The rod 15 may be an antenna of a portable audio communication device. In this case, an additional rod is not included, and thus the body 11 can be compact and light.

The rod 15 is combined with the body 11 through a hinge 18. The rod 15 can be folded toward the body 11 and then can be retracted from the body 11 when information is required to be input, so as to function in an information input mode. For this purpose, a sensor (not shown) may be provided at a side of the hinge 18 to sense whether the rod 15 is retracted at an easy position through a manipulation of a user. Since the rod 15 is retracted from the body 11 at any time, the external appearance of the body 11 is compact, and the body 11 can be easily carried. A cap 17 may be further provided at an end of the rod 15 so that the user can grasp the cap 17 to easily retract the rod 15 from the body 11.

The use of the hinge 18 with the rod 15 is an example of a retractable combination structure, and the rod 15 may be combined with the body 11 in a retractable structure or a toggle structure. Such a combination structure may be adopted when an antenna is combined with a body, and a detailed description of such a combination structure will be omitted herein. Furthermore, the rod 15 is not limited to being combined with the body 11 in order to be retracted from the body 11 but the rod 15 may be fixedly combined with the body 11.

The movable ring 16 may longitudinally slide along the rod 15 or may rotate around the rod 15 through a manipulation of the user. In the present exemplary embodiment, an elastic member such as a spring may be interposed between the rod 15 and the movable ring 16 so that the movable ring 16 moves through the manipulation of the user and then returns to its original position. In the present exemplary embodiment, the movable ring 16 longitudinally moves and rotates on the rod 15. However, the movable ring 16 may longitudinally move or rotate around the rod 15.

FIG. 2 is a schematic perspective view illustrating the information inputting device illustrated in FIG. 1, according to an exemplary embodiment of the present invention. Referring to FIG. 2, the information inputting device 10 according to the present exemplary embodiment further includes a detector 20 that is positioned between the rod 15 and the movable ring 16 to sense a motion of the movable ring 16 on the rod 15 so as to output direction key information.

The detector 20 includes first and second sensors 21 and 22 and a rotation sensor 24. The first sensor 21 of the detector 20 senses a movement of the movable ring 16 of the detector 20 toward a first longitudinal direction. The second sensor 22 of the detector 20 senses a movement of the movable ring 16 of the detector 20 toward a second longitudinal direction opposite to the first longitudinal direction. The rotation sensor 24 senses a rotation direction of the movable ring 16 on the rod 15.

For example, the first and second sensors 21 and 22 may be contact point switches. In the present exemplary embodiment, the first sensor 21 includes a first fixed contact point (not shown) provided on an outer surface of the rod 15 and a first operating contact point (not shown) provided on an inner surface of the movable ring 16. The second sensor 22 includes a second fixed contact point (not shown) provided on the outer surface of the rod 15 and a second operating contact point (not shown) provided on the inner surface of the movable ring 16. When the movable ring 16 moves towards the first longitudinal direction along the rod 15, i.e., to the left, the first fixed contact point of the first sensor 21 contacts the first operating contact point of the first sensor 21, and the first sensor 21 generates first direction key information. When the movable ring 16 moves towards the second longitudinal direction along the rod 15, i.e., to the right, the second fixed contact point of the second sensor 22 contacts the second operating contact point of the second sensor 22, and the second sensor 22 generates second direction key information.

For example, the rotation sensor 24 of the detector 20 may be a rotary switch. In the present exemplary embodiment, the rotation sensor 24 includes a plurality of fixed contact points (not shown) provided along the outer surface of the rod 15 and a plurality of rotation contact points (not shown) provided along the inner surface of the movable ring 16. When the movable ring 16 rotates clockwise and counterclockwise, the plurality of fixed contact points of the rotation sensor 24 contact the plurality of rotation contact points of the rotation sensor 24, and the rotation sensor 24 generates third and fourth direction key information respectively. The third and fourth direction key information may be distinguished from each other according to a variation in a phase difference of a pulse signal generated from the rotation sensor 24 when the rotational direction of the movable ring 16 is changed. The rotation sensor 24 may measure a rotation direction, a rotation amount, or a rotation speed of the movable ring 16. The rotation sensor 24 may measure the number of pulse signals or intervals between pulse signals to measure a rotation amount or rotation speed of the movable ring 16. As will be described later, a scroll speed for scrolling a screen may vary depending on the rotation amount or the rotation speed of the movable ring 16 so as to more effectively input the rotation amount or rotation speed.

The first and second direction key information of the detector 20 corresponds to left and right direction key information of the related art four direction key information, and the third and fourth direction key information corresponds to up and down direction key information of the related art four direction key information.

In the related art, direction keys include a confirmation button through which a selected manipulation menu is executed, besides the four direction keys. In the present exemplary embodiment, an additional confirmation button is not included, but the second sensor 22 of the detector 20 may operate as a confirmation button. The case where the second sensor 22 of the detector 20 is used as the confirmation button will be described later in a method of inputting information. However, an additional confirmation button may be included to further easily confirm a manipulation menu. That is, an additional confirmation button may be provided at the cap 17 provided at an end of an antenna or may be additionally provided at the body 11 or the movable ring 16.

In the present exemplary embodiment, the display 50 is provided on the body 11 so that the user selects and executes a manipulation menu from a manipulation menu list displayed on a screen of the display 50 to input direction key information using a graphic user interface (GUI). For example, the display 50 may be an image display device such as a liquid crystal display (LCD).

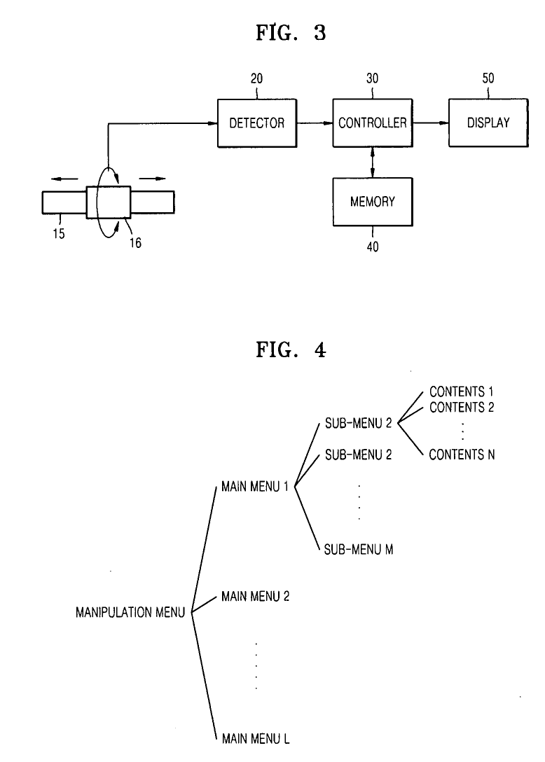

FIG. 3 is a schematic block diagram illustrating the information inputting device 10 illustrated in FIG. 1, according to an exemplary embodiment of the present invention;

Referring to FIG. 3, the detector 20 detects movements of the movable ring 16 on the rod 15 as first through fourth direction key information and transmits the first through fourth direction key information to a controller 30. The controller 30 distinguishes currently input direction key information with reference to a memory 40 that stores direction key values and displays a manipulation menu on the display 50 or executes the manipulation menu on the display 50.

An exemplary embodiment of the present invention suggests a new direction key information inputting method by which the movable ring 16 that is fitted over the rod 15 can be moved towards the first and second longitudinal directions along the rod 15 so as to input left and right direction key information and is rotated clockwise or counterclockwise on the rod 15 to input up and down direction key information. As described above, the user can move the movable ring 16 towards the first and second longitudinal directions along the rod 15 and can rotate the ring 15 clockwise or counterclockwise on the rod 15 to input direction key information. Thus, the information inputting device 10 according to the present invention can provide the user with a different manipulation feeling, pleasure of use, and ease of use.

The method of inputting information according to an exemplary embodiment of the present invention will now be described with reference to FIGS. 4 through 7.

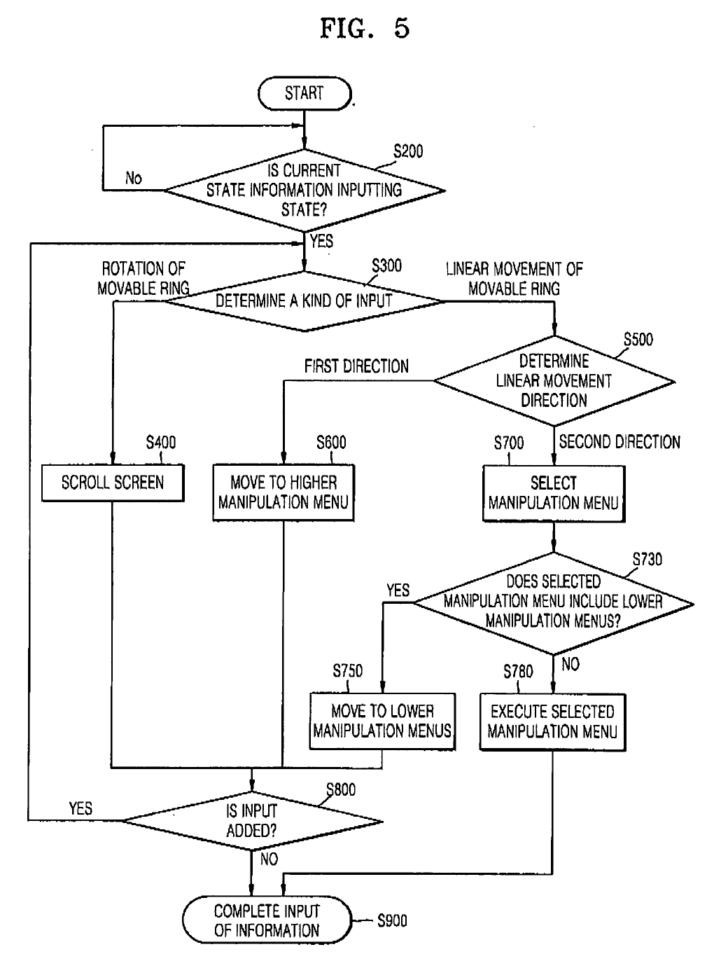

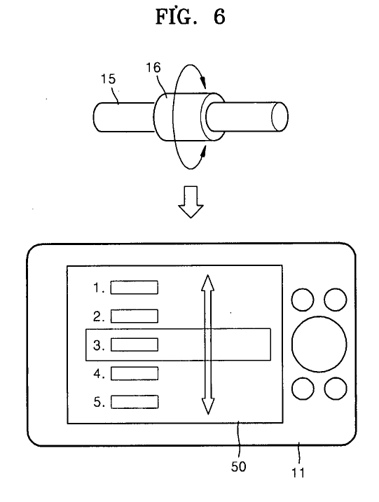

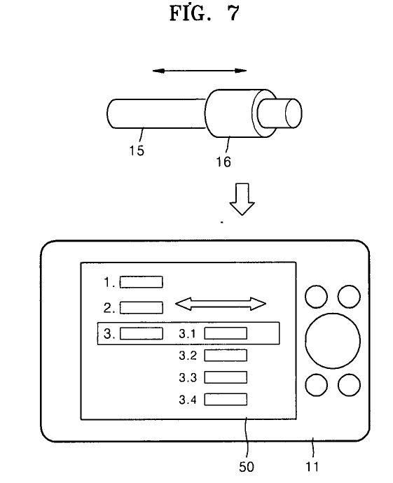

FIG. 4 is a view illustrating a tree structure of a manipulation menu, according to an exemplary embodiment of the present invention. FIG. 5 illustrates a flowchart of the method of inputting information according to an exemplary embodiment of the present invention. FIGS. 6 and 7 are views illustrating a manipulation menu of a display with information input by direction keys according to exemplary embodiments of the present invention.

An information inputting device of the present invention is suitable for a plurality of manipulation menus arranged in a tree structure as shown in FIG. 4. In particular, as will be described later, a menu that is to be selected may be easily searched from menus including many contents on a layer.

Referring to FIG. 5, in operation S200, a determination is made as to whether a current state is an information inputting state. A position state of the rod 15 of the information inputting device 10 of FIG. 1 in the body 11 of FIG. 1 is determined to determine whether the current state is the information inputting state in operation S200. For example, if the rod 15 is combined with the body 11 through the hinge 18 of FIG. 1, the current state is determined as the information inputting state when the rod 15 is retracted at an angle at which a user can easily manipulate the rod 15. As another example, if the rod 15 is toggled in the body 11, the current state is determined as the information inputting state when an end of the rod 15 is extracted so that the rod 15 protrudes from the body 11. If it is determined that the current state is the information inputting state as described above, the first and second sensors 21 and 22 and the rotation sensor 24 of the detector 20 disposed between the rod 15 and the movable ring 16 are in a mode in which movement of the movable ring 16 can be detected.

In operation S300, direction key information detected by the detector 20 is input to the controller 30, and the controller 30 determines the kind of input detected by the detector 40 with reference to FIG. 4. In the present exemplary embodiment, the kind of input detected by the detector 40 may be greatly divided into an input of first and second direction key (left and right direction key) information depending on a longitudinal movement of the movable ring 16 along the rod 15 and an input of third and fourth direction key (up and down direction key) information depending on a rotation of the movable ring 16 around the rod 15.

If the movable ring 16 is rotated by a manipulation of the user, the rotation sensor 24 of the detector 20 senses the rotation of the movable ring 16 to generate the third and fourth direction key information depending on the rotation of the movable ring 16 around the rod 15. The third and fourth direction key information is input to the controller 30, and the controller 30 generates data for scrolling a screen including a plurality of manipulation menus. In the present exemplary embodiment, a scrolled manipulation menu list is a manipulation menu list on the same layer of the tree structure shown in FIG. 4. In operation S400, the data for scrolling the screen including the plurality of manipulation menus is input to the display 50 and scrolled on the screen as shown in FIG. 6. If the movable ring 16 rotates clockwise, the detector 20 generates the third direction key information and the manipulation menu list on the same layer is scrolled upwards on the display 50. If the movable ring 16 rotates counterclockwise, the detector 20 generates the fourth direction key information and the manipulation menu list on the same layer is scrolled downward. In the present exemplary embodiment, a manipulation menu of the scrolled manipulation menu list is basically highlighted or displayed as a different color to easily select a manipulation that is to be searched. For example, if the highlighted manipulation menu is sub-menu I in the tree structure in the manipulation menu shown in FIG. 4, sub-menus 2, 3, . . . , and M on the same layer as the sub-menu 1 are scrolled and displayed downwards on the display 50 through the fourth direction key information.

The rotation sensor 24 may measure not only a rotation direction but a rotation amount, or a rotation speed of the movable ring 16. This measurement of the rotation amount or the rotation speed is useful when a manipulation menu is to be selected from many manipulation menus.

If the rotation sensor 24 measures the rotation amount, the scrolling speed may be rapidly increased or decreased in proportion to the rotation amount of the movable ring 16. If a manipulation menu that is to be selected is adjacent to the highlighted manipulation menu, the movable ring 16 slightly rotates to reduce the scrolling speed so as to not miss the manipulation menu that is to be selected. If the manipulation menu that is to be selected is distant from the highlighted manipulation menu, the movable ring 16 rotates more to increase the scrolling speed so as to rapidly search for the manipulation menu that is to be selected.

As another example, if the rotation sensor 24 measures the rotation speed, the scrolling speed may be rapidly increased in proportion to the rotation speed of the movable ring 16. If the manipulation menu that is to be selected is adjacent to the highlighted manipulation menu, the movable ring 16 slowly rotates to reduce the scrolling speed so as to not miss the manipulation menu that is to be selected. If the manipulation menu is distant from the highlighted manipulation menu, the movable ring 16 rapidly rotates to increase the scrolling speed so as to rapidly search for the manipulation menu that is to be selected.

As described above, the rotation sensor 24 may measure the rotation amount or the rotation speed of the movable ring 16 to rapidly search for a manipulation menu from a plurality of manipulation menus so as to reduce a search time. Particularly, the time required to search for contents can be considerably reduced in a multimedia device such as an MP3 or a PMP that selects and executes one of hundreds or thousands contents. Thus, the convenience to a user when using such devices as an MP3 or a PMP can be increased.

If the movable ring 16 longitudinally moves along the rod 15 through a manipulation of the user, the first and second sensors 21 and 22 sense the longitudinal movement of the movable ring 16 to generate the first and second direction key information depending on the longitudinal movement along the rod 15. In operation S500, the first and second direction key information of the first and second sensors 21 and 22 is input to the controller 30, and the controller 30 determines whether to move to a manipulation menu (hereinafter referred to as a higher manipulation menu) on a higher layer than the highlighted manipulation menu or to select the highlighted manipulation menu. In the present exemplary embodiment, the first and second directions correspond to left and right directions in the related art but such designation may be reversed according to an input method.

If the first direction key information is input to the controller 30, the controller 30 determines the first direction key information as a signal to move to the higher manipulation menu, generates data of the higher manipulation menu of the highlighted manipulation menu, and outputs the data to the display 50 in operation S600. For example, if the highlighted manipulation menu is the sub-menu 1 in the tree structure of the manipulation menu shown in FIG. 4, main menus 1, 2, . . . , and L are displayed as higher menus of the sub-menu 1 on the display 50 through the first direction key information.

If the second direction key information is input to the controller 30, the controller 30 selects the highlighted manipulation menu in operation S700. In operation S730, a determination is made as to whether the selected manipulation menu includes manipulation menus (hereinafter referred to as lower manipulation menus) on a lower layer.

If the controller 30 determines that the selected manipulation menu includes the lower manipulation menus, the controller 30 determines the second direction key information as a signal to move to the lower manipulation menus, generates data of the lower manipulation menus, and displays the lower manipulation menus in operation S750. For example, if the highlighted manipulation menu is the sub-menu 1 in the tree structure of the manipulation menu shown in FIG. 4, contents 1, 2, . . . , and N are displayed as lower manipulation menus of the sub-menu 1 on the display 50.

If the controller 30 determines that the selected manipulation menu does not include lower manipulation menus, the controller 30 determines the second direction key information as a signal to execute the selected manipulation menu, i.e., a confirmation signal, and executes the selected manipulation menu in operation S780. For example, if the highlighted manipulation menu is the contents 1, the contents 1 is executed by the second direction key information. The confirmation signal may be used as the second direction key information to select and execute a desired manipulation menu from a plurality of manipulation menus without an additional confirmation button. The additional confirmation button such as the cap 17 may be used instead of operation S780 to execute the selected manipulation menu.

After operations S400, S600, and S750, the controller 30 is in a standby mode to determine whether an additional input has been performed in operation S800. If it is determined in operation S800 that the additional input has been performed, the process returns to operation S300 to finally select a desired manipulation menu so as to complete an information input in operation S900.

It has been described in the above-described exemplary embodiments that information processed by the detector 20 and the controller 30 is first through fourth direction key information. However, the information processed by the detector 20 and the controller 30 is not limited to this. The information processed by the detector 20 and the controller 30 may be information for executing a specific manipulation menu or letter information generated through a combination of a longitudinal movement along the rod and a rotation around the rod.

Furthermore, it has been described in the exemplary embodiments of the present invention that an operation ring longitudinally moves along the ring and rotates around the ring. However, the movable ring may longitudinally move or rotate. In this case, only information input corresponding to a longitudinal movement or information input corresponding to a rotation may be possible.

As described above, in a device and a method for inputting information according to an exemplary embodiment of the present invention, the device can be realized in a protruding structure such as an antenna. Thus, a body such as a mobile device can be compact. Also, the time required for searching and moving to a plurality of manipulation menu lists can be reduced. In addition, the device can provide a user with a new information inputting method to provide the user with a unique manipulation feeling and pleasure to use.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. An information inputting device comprising:
a rod;
a movable ring fitted over the rod such that the rod is inserted through the movable ring, the movable ring moving in at least one of a longitudinal direction of the rod and a rotational direction around the rod; and
a detector provided on the rod to sense a movement of the movable ring in order to generate information corresponding to the movement of the movable ring.

2. The information inputting device of claim 1, wherein the information is direction key information corresponding to one of the longitudinal direction and the rotational direction along which the movable ring on the rod moves.

3. The information inputting device of claim 1, wherein the linear movement of the movable ring in the longitudinal direction of the rod is one of straight and curved line movements.

4. The information inputting device of claim 1, wherein the rod is combined with the body to be retracted from the body.

5. The information inputting device of claim 4, wherein the rod is attached to the body by a hinge structure or the rod has one of a retractable structure and a toggle structure.

6. The information inputting device of claim 5, further comprising a controller which determines whether a current mode is changed into an information inputting mode based on a position state of the rod in the body.

7. The information inputting device of claim 6, wherein the rod has the retractable structure, and if the rod is extended from the body, the controller changes the current mode into the information inputting mode.

8. The information inputting device of claim 7, wherein the rod is attached to the body by a hinge structure, and if the rod is folded up from the body, the controller changes the current mode into the information inputting mode.

9. The information inputting device of claim 1, wherein the rod is an antenna.

10. The information inputting device of claim 1, wherein the movable ring moves by a manipulation of a user and then returns to the original position of the movable ring.

11. The information inputting device of claim 1, wherein the detector comprises:
a first sensor which senses the movement of the movable ring in a first longitudinal direction along the rod; and
a second sensor which senses the movement of the movable ring in a second longitudinal direction opposite to the first longitudinal direction along the rod,
wherein the detector generates information corresponding to the movement.

12. The information inputting device of claim 11, wherein the detector further comprises a rotation sensor sensing clockwise and counter clockwise rotations of the movable ring around the rod and the detector generates information corresponding to the clockwise and counter clockwise rotations.

13. The information inputting device of claim 1, wherein the detector comprises a rotation sensor which senses clockwise and counter clockwise rotations of the movable ring around the rod and the detector generates information corresponding to the clockwise and counter clockwise rotations around the rod.

14. The information inputting device of claim 13, wherein the rotation sensor detects one of a rotation amount and a rotation speed of the movable ring around the rod.

15. The information inputting device of claim 1, further comprising a confirmation button provided at one of an end of the rod and a side of the rod.

16. The information inputting device of claim 1, further comprising a controller which distinguishes information generated by the detector.

17. The information inputting device of claim 16, further comprising a display which displays the information distinguished by the controller.

18. The information inputting device of claim 17, wherein the information generated by the detector is direction key information, and the controller displays or executes a manipulation menu corresponding to the information on the display.

19. The information inputting device of claim 18, wherein the detector senses a longitudinal movement direction of the movable ring on the rod, and manipulation menus on different layers are displayed on the display according to the longitudinal movement direction of the movable ring on the rod.

20. The information inputting device of claim 19, wherein the detector senses a rotation direction of the movable ring around the rod, and manipulation menus on an identical layer are scrolled up and down and displayed on the display according to the rotation direction of the movable ring around the rod.

21. The information inputting device of claim 18, wherein the detector senses a rotation direction of the movable ring around the rod, and manipulation menus on an identical layer are scrolled up and down and displayed on the display according to the rotation direction of the movable ring around the rod.

22. A method of sensing a movement of a movable ring that is fitted over a rod such that the rod is inserted through the movable ring, the ring moving as in at least one of a longitudinal direction of the rod and a rotational direction around the rod, to input information, the method comprising:
sensing a movement of the movable ring on the rod; and
generating information corresponding to the sensed movement.

23. The method of claim 22, wherein the sensing of the movement of the movable ring comprises sensing one of a rotation of the movable ring around the rod and a longitudinal movement of the movable ring on the rod.

24. The method of claim 23, wherein the generating information corresponding to the sensed movement comprises sensing clockwise and counterclockwise rotations of the movable ring around the rod to generate direction key information corresponding to a rotation direction.

25. The method of claim 24, wherein the generating information corresponding to the sensed movement further comprises generating data for scrolling a screen which displays at least one manipulation menu of a plurality of manipulation menus on an identical layer, wherein the generated data corresponds to direction key information corresponding to the rotation direction.

26. The method of claim 25, wherein a speed of scrolling the screen is proportional to one of a rotation amount and a rotation speed of the movable ring on the rod.

27. The method of claim 24, wherein the generating information corresponding to the sensed movement comprises sensing a movement of the movable ring in a first longitudinal direction or in a second longitudinal direction that is opposite to the first longitudinal direction in order to generate direction information key corresponding to a longitudinal movement direction.

28. The method of claim 27, wherein the generating information corresponding to the sensed movement further comprises generating data for displaying at least one manipulation menu of a plurality of manipulation menus on different layers, wherein the data corresponds to direction key information corresponding to the longitudinal movement direction.

29. The method of claim 27, wherein the generating information corresponding to the sensed movement comprises selecting one of a plurality of manipulation menus corresponding to direction key information corresponding to the longitudinal movement direction.

30. The method of claim 23, wherein the generating information corresponding to the sensed movement comprises sensing a longitudinal movement of the movable ring in a first longitudinal direction or in a second longitudinal direction that is opposite to the first longitudinal direction in order to generate direction information key corresponding to a longitudinal movement direction.

31. The method of claim 30, wherein the generating information corresponding to the sensed movement further comprises generating data for displaying at least one manipulation menu of a plurality of manipulation menus on different layers, wherein the data corresponds to direction key information corresponding to the longitudinal movement direction.

32. The method of claim 30, wherein the generating information corresponding to the sensed movement comprises selecting one of a plurality of manipulation menus corresponding to direction key information corresponding to the longitudinal movement direction.

33. The method of claim 22, further comprising determining whether a current mode is changed into an information inputting mode based on a position state of the rod in a body of an information inputting device.

34. The method of claim 33, wherein the rod is attached to the body of the information inputting device through a hinge and if the rod folded up from the body of the information inputting device, the current mode is changed into the information inputting mode.

35. The method of claim 33, wherein the rod has a retractable structure, and if the rod extends from the body of the information inputting device, the current mode is changed into the information inputting mode.
